(19) United States
(12) Patent Application Publication
(10) Pub. No.: US 2011/0005485 A1
(43) Pub. Date: Jan. 13, 2011

(54) INSULATOR FOR SPARK PLUG, PROCESS FOR PRODUCING THE INSULATOR, SPARK PLUG, AND PROCESS FOR PRODUCING THE SPARK PLUG

(75) Inventors: Hirokazu Kurono, Aichi (JP); Toshitaka Honda, Aichi (JP)

Correspondence Address: KUSNER & JAFFE;HIGHLAND PLACE SUITE 310, 6151 WILSON MILLS ROAD, HIGHLAND HEIGHTS, OH, 44143, US

(73) Assignee: NGK Spark Plug Co., Ltd.

(21) Appl. No.: 12/736,235

(22) PCT Filed: Mar. 24, 2009
(86) PCT No.: PCT/JP2009/055750

§ 371 Date: Sep. 23, 2010

(30) Foreign Application Priority Data
Mar. 26, 2008 (JP) 2008-081262

(51) Int. Cl. H01T 13/08; B29C 45/14

(52) U.S. Cl. 123/169 R; 264/272.16

(57) ABSTRACT

A method for manufacturing a ceramic insulator for a spark plug.

### FIELD OF THE INVENTION

The invention relates to a spark plug used for internal combustion engines, a method for manufacturing the same, and further relates to an insulator used for spark plugs and a method for manufacturing the insulator.

### BACKGROUND OF THE INVENTION

A spark plug for an internal combustion engine is used for ignition to an air-fuel mixture with a combustion chamber. A spark plug is generally comprised of an insulator having an axial bore, a center electrode inserted in a front end of the axial bore, a terminal electrode inserted in a rear end of the axial bore, a metal shell provided in a periphery of the insulator, and a ground electrode forming a spark discharge gap with the center electrode. By applying high voltage to the center electrode, sparks are discharged in the spark discharge gap between two electrodes, and in turn ignites to the air-fuel mixture.

Generally, an insulator is manufactured as follows. Granulated base powder mainly made of alumina is filled in a cylindrical rubber cavity, and then compressed by applying fluid pressure from a radial direction to thereby form a molded body. The thus-formed molded body is cut into a predetermined insulator shape and fired to produce an insulator.

As mentioned above, since the high voltage is applied to a center electrode, spark penetration destruction tends to occur in the insulator provided in an outer circumference of the center electrode, resulting in causing a penetration hole therein. When a penetration hole is formed in the insulator, current leaks from the center electrode to a metal shell, and as a result, a spark discharge does not occur in a spark discharge gap. Therefore, excellent withstand voltage properties are required for the insulator. In recent years, downsizing of spark plugs and decrease in the diameters of spark plugs have been demanded. In order to meet such a demand, thinner insulator has been required, and a further improvement in withstand voltage properties is necessary.

Thus, in order to reduce holes in the insulator which causes spark penetration destruction, variation in compression strength of the particles which constitute the granulated base powder is reduced so that the number of holes in the molded body can be reduced (see Japanese Patent Application Laid-Open (kokai) No. H9-25171). This technique enables to prevent an inhibition of pressure propagation that is caused by particles that have small compression strength and are easily crushed with a low pressure when pressure is applied. As a result, the particles are uniformly crushed and the number of holes in the molded body can be reduced.

When manufacturing an insulator as mentioned above, a molded body is produced by compressing a granulated base powder in a radial direction using a rubber die. When a pressure molding is conducted using a metallic mold, generally uniform pressure can be applied to the granulated base powder. On the other hand, when the rubber die is employed for pressure molding, it is difficult to apply pressure to the granulated base powder in a direction perpendicular to the radial direction of the rubber die. Thus, even if the above-mentioned technique is adopted in order to prevent a variation of compression strength, there is still a possibility that particles having large compression strength are not crushed and the number of holes in the molded body cannot be sufficiently reduced.

The present invention is accomplished in view of the above-mentioned problems. An object of the present invention is to provide an insulator for spark plugs and a method for manufacturing the same. Another object of the present invention is to provide a spark plug having the insulator and a method for manufacturing the spark plug.

### SUMMARY OF THE INVENTION

Each aspect of the present invention, which is suitable for solving the above-mentioned problems, will be described in the following paragraphs. In addition, an effect specific to the aspect will be described if necessary.

According to a first aspect of the present invention, there is provided a method for manufacturing an insulator that is used for spark plugs and that has an axial bore extending in an axis direction, the method comprising the steps of:

preparing a slurry by mixing a base powder into a solvent, the base powder containing aluminum oxide powder as a principal component and one or more kinds of a sintering aid including silicon oxide;

granulating the slurry by spray drying to obtain granulated base powder;

filling the granulated base powder into a cavity of a cylindrical rubber die for molding;

compressing the granulated base powder by applying a pressure from a radial direction of the rubber die after disposing a rod-like press pin in the cavity so as to form a molded body;

cutting the molded body into a insulator intermediate body having a predetermined insulator shape,

wherein a mean particle size of particles which constitute the granulated base powder falls within a range from 60 micrometers or more to 120 micrometers or less, and

wherein granule strength of the granulated base powder is 1 MPa or less.

As used herein, the terms “cylindrical” does not strictly mean a cylindrical shape (i.e., non-bottomed shape), but it also includes a bottomed cylindrical shape.

According to the first aspect, since the granule strength of the granulated base powder is 1 MPa or less, the particles constituting the granulated base powder can be uniformly crushed even when the rubber press whose pressure is less likely propagated uniformly is used. Therefore, the number of pores in the molded body is lowered, i.e., the number of pores in the insulator is also reduced.

Since the mean particle size of the particles constituting the granulated base powder is relatively small, falling within the range from 60 micrometers or more to 120 micrometers or less, the size of pore formed between the particles can be relatively small.

According to the first aspect, even when the rubber press whose pressure is less likely propagated is used for the manufacturing of the ceramic insulator for spark plugs, the number of pores formed in the insulator is reduced, and also the size of pore becomes small. Thus, the density, as well as the withstand voltage properties of the insulator are substantially improved.

In addition, when the mean particle size of the particles constituting the granulated base powder is less than 60 micrometers, there is a possibility that mobility of the granulated powder may fall and the handling thereof is likely to deteriorate.

In accordance with a second aspect of the present invention, there is provided a the method for manufacturing the insulator used for spark plugs as described above, wherein a molding pressure in the compressing process falls within a range from 50 MPa or more to 150 MPa or less.

According to the second aspect, the molding pressure applied to granulated base powder in the compressing process is 50 MPa or more. Thereby, the granulated base powder having the granule strength of 1 MPa or less can be assuredly compressed, and the pores in the molded body can be certainly reduced. As a result, the pores formed in the insulator can be further reduced, and improvement in withstand voltage properties is achievable.

Although the granulated base powder can be fully compressed by increasing the molding pressure, the rubber die for molding is rapidly worn off when the molding pressure exceeds 150 Mpa. This leads to an increase in a manufacturing cost. Further, when applying the molding pressure of over 150 Mpa, it is necessary to change a pressurization pump to a larger size for a greater pressure. Therefore, the molding pressure is preferably 150 MPa or less.

In accordance with a third aspect of the present invention, there is provided a method for manufacturing the insulator for spark plugs as described above, wherein a cutting amount of the molded body in the cutting process is less than 50% by mass of the molded body.

As mentioned above, in the rubber press molding using the rubber die, the pressure is applied to the granulated base powder in the radial direction. In view of the density of the molded body, an outer circumferential portion, which is in contact with the rubber die and the press pin, and an inner circumferential portion of the molded body and the vicinity thereof have relatively high density. On the other hand, an intermediate portion located between the outer circumferential portion and the inner circumferential portion has relatively low density. Particularly, when the molded body is made relatively thick, the difference in density of the outer circumferential portion, the inner circumferential portion, and the intermediate portion becomes great. When the cutting amount of the molded body in the cutting process increases (i.e., when the molded body is made much thicker than the thickness of the insulator intermediate body), the difference in density among the outer circumferential portion, the inner circumferential portion and the intermediate portion becomes great. Further, an outer circumferential portion of the insulator intermediate body formed through the cutting process corresponds to the intermediate portion of the molded body where the density is relatively low. As a result, the insulator intermediate body, consequently, the insulator tends to have non-uniform density in which the outer circumferential portion thereof has a relatively low-density and the inner circumferential portion thereof has a relatively high-density. This may cause deterioration in withstand voltage properties.

According to the third aspect, the insulator intermediate body is formed by cutting the molded body with the cutting amount of less than 50% mass of the molded body. Thus, it is less likely that the molded body is made much thicker than the insulator intermediate body. Also, the difference in density among the outer circumferential portion, the inner circumferential portion and the intermediate portion of the molded body is made relatively small (i.e., the density of the molded body becomes generally uniform). As a result, the insulator intermediate body, consequently, the ceramic insulator is less likely to have non-uniform density among the outer circumferential portion, the inner circumferential portion and the intermediate portion thereof. This contributes to a further improvement in withstand voltage properties.

Since the cutting amount can be controlled in the cutting process, it is possible to prevent an increment of the manufacturing cost.

In accordance with a fourth aspect of the present invention, there is provided a method for manufacturing the insulator as described above, wherein the press pin is comprised of:

a small diameter portion formed at a front end side thereof;

a large diameter portion formed at a rear end side with respect to the small diameter portion and having a larger diameter than that of the small diameter portion; and

one or more step portion formed between the small diameter portion and the large diameter portion and tapering off toward the front end side,

wherein the granulated base powder is filled in the filling process so as to cover at least the step portion.

Generally, a shoulder portion is formed at the front end side of the axial bore of the insulator so as to be engaged with an end of the center electrode. Here, a portion of the insulator which corresponds to the outer circumference of the shoulder portion and the vicinity thereof is, directly or through a plate packing, pressed very hard against the metal shell when assembling the insulator into the metal shell. Therefore, the portion forming the shoulder portion of the insulator preferably has excellent mechanical strength and withstands voltage properties.

However, the shoulder portion is generally formed using the step portion of the press pin. Since the step portion tapers off toward the front end side, the pressure applied from the radial direction is likely to escape at the time of press molding. Therefore, many pores are likely to be formed in the portion forming the shoulder portion of the insulator. This tends to lead to deterioration in durability and withstand voltage properties.

According to the fourth aspect, since the molded body is made of relatively fine granulated base powder having the granule strength of 1 MPa or less, the particles of granulated base powder can assuredly be crushed even when the pressure applied from the radial direction escapes to some extent. Thus, the pores in the portion forming the shoulder portion can be decreased, and density of the portion can be further improved. As a result, the mechanical strength and the withstand voltage properties can be improved.

In accordance with a fifth aspect of the present invention, there is provided a method for manufacturing an insulator for spark plugs as described above, wherein a hardness of the rubber die for molding falls within the range from 40 Hs or more to 90 Hs or less.

According to the fifth aspect, since the hardness of the rubber die falls within the range from 40 Hs or more to 90 Hs or less, the granulated base powder can be assuredly compressed and molded while the rubber die maintains a sufficient durability.

When the hardness of the rubber die is less than 40 Hs, the durability of the rubber die tends to be insufficient. On the other hand, when the hardness of the rubber die exceeds 90 Hs, the pressure is not fully applied to the granulated base powder, causing deterioration or the like in density of the molded body.

In accordance with a sixth aspect of the present invention, there is provided an insulator for spark plugs that is manufactured by the method described above.

Since the insulator for spark plugs according to the sixth aspect is manufactured by the method according to the first aspect or the like, it exhibits excellent withstand voltage properties.

In accordance with a seventh aspect of the present invention, there is provided a spark plug with an insulator according to the sixth aspect.

Since the spark plug according to the seventh aspect is provided with the insulator having excellent withstand voltage properties, improvement in durability and the long service life of the spark plug are achievable.

In accordance with an eighth aspect Of the present invention, there is provided a method for manufacturing a spark plug as described above, wherein the spark plug is manufactured using the insulator that is manufactured according to any one of the aspects 1 to 5.

According to the eighth aspect, the above-mentioned technical concept may be embodied to a method for manufacturing of a spark plug. In this case, the same effects as the first aspect or the like are basically materialized.

### BRIEF DESCRIPTION OF THE DRAWINGS

FIG. 1 is a partially fractured cross-sectional front view of a spark plug according to an embodiment.

FIG. 2 is a front view of a ceramic insulator or the like in an embodiment.

FIG. 3 is an enlarged view of a rubber press or the like for describing a manufacturing process of the ceramic insulator.

FIG. 4 is an enlarged view of a rubber press or the like for describing a manufacturing process of the ceramic insulator.

FIG. 5 is an enlarged view of a rubber press or the like for describing a manufacturing process of the ceramic insulator.

FIG. 6 is a graph showing a relationship between granule strength and withstands voltage.

FIG. 7 (a) is a cross-sectional face of granulated base powder corresponding to a comparative example, and (b) is a cross-sectional face of granulated base powder corresponding to an embodiment.

FIG. 8 is a graph showing a relationship between mean particle size and relative density of the particles that constitute granulated base powder.

FIG. 9 is a graph showing a relationship between molding pressure and relative density.

FIG. 10 is a graph showing a relationship between hardness of rubber die for molding and relative density of a sample.

### DETAILED DESCRIPTION OF PREFERRED EMBODIMENTS

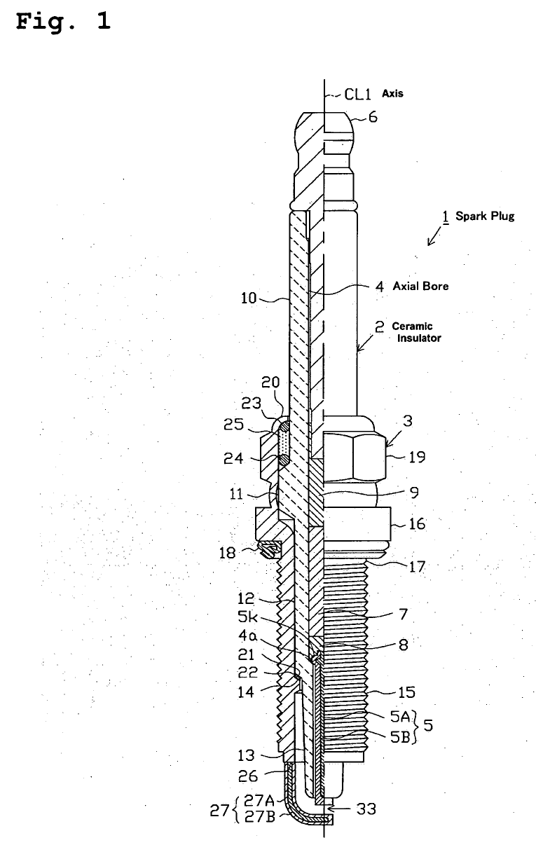

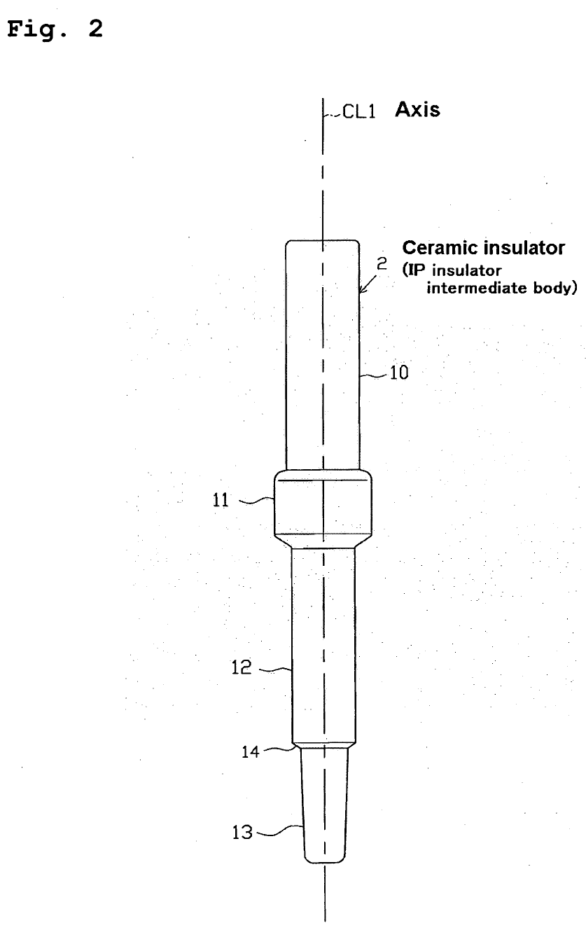

An embodiment of the present invention will be described with reference to the drawings. FIG. 1 is a partially sectioned, front view showing a spark plug 1. FIG. 2 is a front view of a ceramic insulator 2 serving as an insulator for spark plugs. In FIGS. 1 and 2, an axis Cl direction of the spark plug 1 is referred to as the top-to-bottom direction in the drawing. A lower side of the drawing is referred as a front end side, and an upper side of the drawing is referred as a rear end side of the spark plug 1.

The spark plug 1 is comprised of a cylindrical ceramic insulator 2 and a cylindrical metal shell 3 holding therein the ceramic insulator 2.

The ceramic insulator 2 is made of sintered alumina or the like as is commonly known. The ceramic insulator 2 includes a rear end side body portion 10 formed on the rear end side, a large diameter portion 11 radially outwardly projecting at the front end side with respect to the rear end side body portion 10, a middle body portion 12 having an outer diameter smaller than that of the large diameter portion 11 and located forward with respect to the large diameter portion 11, and an insulator nose 13 having an outer diameter smaller than that of the middle body portion 12 and located forward with respect to the middle body portion 12. In the ceramic insulator 2, the large diameter portion 11, the middle body portion 12 and most of the insulator nose 13 are accommodated in the metal shell 3. A taper-shaped step portion 14 is formed in a connecting portion between the insulator nose 13 and the middle body portion 12 so that the ceramic insulator 2 is engaged with the metal shell 3.

Furthermore, the insulator 2 has an axial bore 4 extending along the axis CL1. A center electrode 5 is inserted and fixed in a front end side of the axial bore 4. More particularly, the center electrode 5 is fixed while a bulged portion 5k formed in the rear end of the center electrode 5 is engaged with a shoulder portion 4a formed in the front end side of the axial bore 4. Further, the center electrode 5 is comprised of an inner layer 5A made of copper or a copper alloy and an outer layer 5B made of a Ni alloy containing nickel (Ni) as a principal component. Furthermore, the center electrode 5 assumes a rod-like shape (columnar shape) as a whole, and a flat front end face thereof projects from the front end of the ceramic insulator 2.

A terminal electrode 6 is inserted and held at a rear end side of the axial bore 4 while projecting from the rear end of the ceramic insulator 2.

Furthermore, a columnar resistor 7 is disposed between the center electrode 5 and the terminal electrode 6 in the axial bore 4. Both ends of the resistor 7 are electrically connected to the center electrode 5 and the terminal electrode 6, respectively, through conductive glass seal layers 8 and 9.

The metal shell 3 is made of a low carbon steel material and assumes a cylindrical shape. A thread (male thread) 15 used for mounting the spark plug 1 on an engine head is formed on an outer circumferential face of the metal shell 3. Further, a seat 16 is formed on the outer circumferential face at the rear end side of the thread 15, and a ring-shape gasket 18 is provided on a thread neck 17 formed at the rear end of the thread 15. A hexagonal tool engagement portion 19, viewed in a cross-section, used for engaging with a tool, such as a wrench, that is used for mounting the metal shell 3 on the engine head is formed at the rear end side of the metal shell 3. Further, a caulking portion 20 for holding the ceramic insulator 2 is formed at the rear end portion of the metal shell 3.

Further, the metal shell 3 has a taper-shaped step portion 21 at an inner circumferential face thereof so as to engage with the ceramic insulator 2. The ceramic insulator 2 is inserted toward the front end side from the rear end side of the metal shell 3 and an opening portion of the rear end side of the metal shell 3 is radially inwardly caulked (i.e., forming the caulking portion 20) while the taper portion 14 is engaged with the step portion 21 of the metal shell 3. Notably, an annular plate packing 22 is disposed between the step portions 14, 21 of the ceramic insulator 2 and the metal shell 4, respectively. In this way, the airtightness in a combustion chamber is maintained, and the air-fuel mixture entering between the insulator nose 13 of the ceramic insulator 2 exposed to the combustion chamber and an inner circumferential face of the metal shell 3 is prevented from leaking outside.

Furthermore, in order to make a perfect sealing with caulking, in the rear end side of the metal shell 3, annular rings 23 and 24 are disposed between the metal shell 3 and the ceramic insulator 2, and talc powder 25 is filled between the rings 23, 24. That is, the metal shell 3 holds the ceramic insulator 2 through the plate packing 22, the rings 23, 24 and the talc 25.

Moreover, a ground electrode 27 is joined to a front end face 26 of the metal shell 3, and a front end side of the ground electrode 27 is bent so that a side face of the ground electrode 27 faces a front end portion of the center electrode 5. The ground electrode 27 has a two-layer construction comprised of an outer layer 27A and an inner layer 27B. In this embodiment, the outer layer 27A is made of a nickel alloy (e.g., Inconel 600 and Inconel 601 (registered trademarks)). On the other hand, the inner layer 27B is made of a copper alloy or pure copper having excellent conductive properties compared to the Ni alloy. Further, a spark discharge gap 33 is formed between the front end portion of the center electrode 5 and the front end side face of the ground electrode 27.

Next, a method for manufacturing the spark plug 1 will be described. First, the metal shell 3 is prepared beforehand. That is, a through-hole is formed in a columnar-shaped metal material (e.g., iron material or stainless steel material, such as S17C and S25C) by a cold forging processing to produce a primary body of the metal shell 3. Then, an outer shape of the thus-produced body is prepared by a cutting process to thereby form a metal shell intermediate body.

Next, the ground electrode 27 made of Ni alloy or the like is joined by resistance welding to a front end face of the metal shell intermediate body. Since the resistance welding causes so-called “rundown”, the thread portion 15 is formed in a predetermined region of the metal shell intermediate by rolling process after removing the “rundown”. In this way, the metal shell 3 to which the ground electrode 27 is welded is obtained. Zinc plating or nickel plating is applied to the metal shell 3 to which the ground electrode 27 is welded. Notably, chromate treatment may be further performed to the surface of the thus-plated metal shell 3 in order to improve corrosion-resistance thereof.

The ceramic insulator 2 is formed separately from the metal shell 3. More particularly, green powder containing, as a principal component, alumina powder (aluminum oxide) with a mean particle size of 0.5 micrometer or more to 3 micrometer or less, and at least one kind of sintering aid, including silicon oxide, with a mean particle size of 1 micrometer or more to 3 micrometer or less is prepared. The thus-prepared green powder is wet mixed with an acrylic binder of 0.5 mass % or more to 2 mass % or less through solvent water so as to form slurry. Then, the slurry is subject to spray-drying to form granulated base powder. The granulated base powder has a mean particle size of 60 micrometers or more to 120 micrometers or less (e.g., 100 micrometers) and granule strength of 1 MPa or less. In addition, the terms “the granule strength” means a value measured (calculated) by a method described below. A particle size of the powder constituting the granulated base powder and a load (breaking load) by which the particles are crushed are measured by a Shimadzu Compression Testing Machine (MCTE-200 produced by Shimadzu Corporation). The measured particle size and the measured breaking load are calculated with an equation of:

2.8×(breaking load)/π×(particle size)².

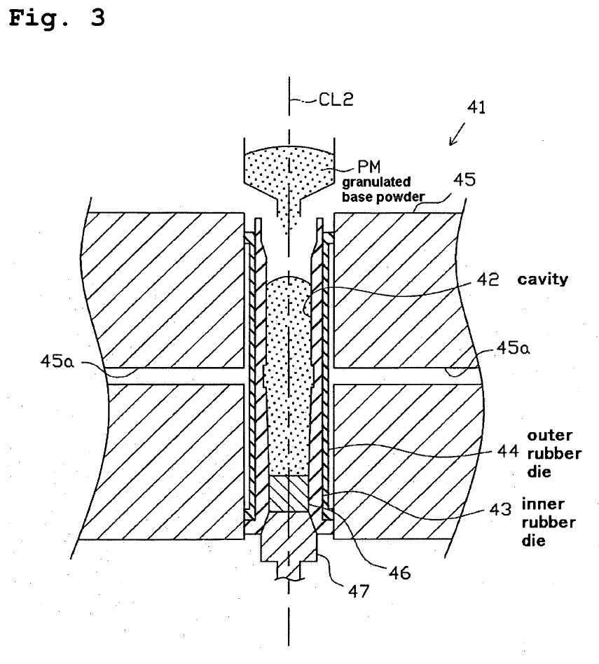

Subsequently, the thus-formed granulated base powder is subjected to rubber press molding using a rubber press machine 41. More particularly, as shown in FIG. 3, the rubber press machine 41 is comprised of a cylindrical inner rubber die 43 having a cavity 42 extending along an axis CL 2, a cylindrical outer rubber die 44 provided on an outer circumference of the inner rubber die 43, a press machine main body 45 provided in an outer circumference of the outer rubber die 44, a base lid 46 and a lower holder 47 for closing the lower opening of the cavity 42. A fluid flow path 45a is formed in the press machine main body 45. The fluid flow path 45a reduces the size of the cavity 42 in the radial direction by applying fluid pressure in the radial direction with respect to the outer circumferential face of the outer rubber die 44. In addition, the inner rubber die 43 and the outer rubber die 44 serve as the rubber die for molding. Each hardness of the inner rubber die 43 and the outer rubber die 44 falls within a range from 40 Hs or more to 90 Hs or less.

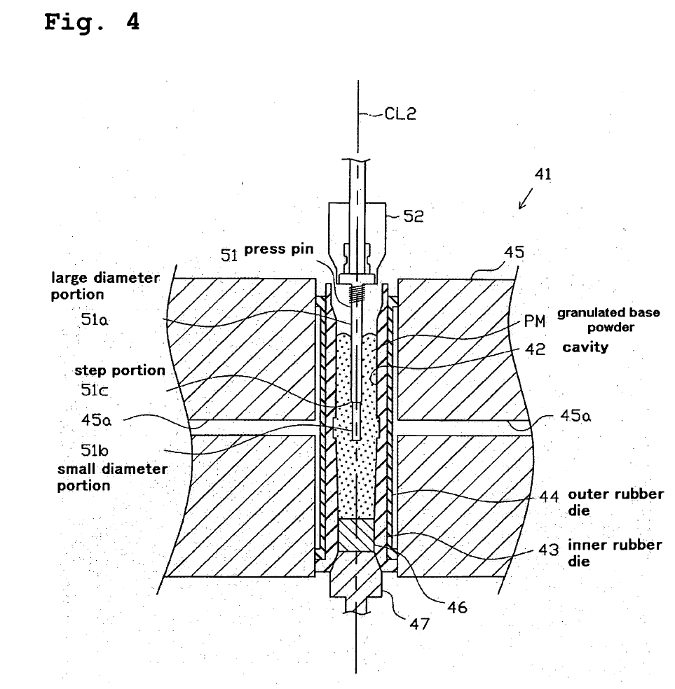

Returning to the description of the manufacturing method, the cavity 42 of the inner rubber die 43 is filled with the granulated base powder PM. Subsequently, as shown in FIG. 4, a press pin 51 is inserted in the cavity 42. An upper holder 52 is integrally formed with a base end portion of the press pin 51 and is engaged with an upper open portion of the cavity 42 to seal the cavity 42 in an airtight condition. The press pin 51 has a large diameter portion 51a at the base end portion thereof, a small diameter portion 51b at a front end portion thereof with a diameter smaller than that of the large diameter portion 51a, and a tapered step portion 51c formed between the large diameter portion 51a and the small diameter portion 51b and tapering toward the front end side (lower side in the drawing) of the press pin 51.

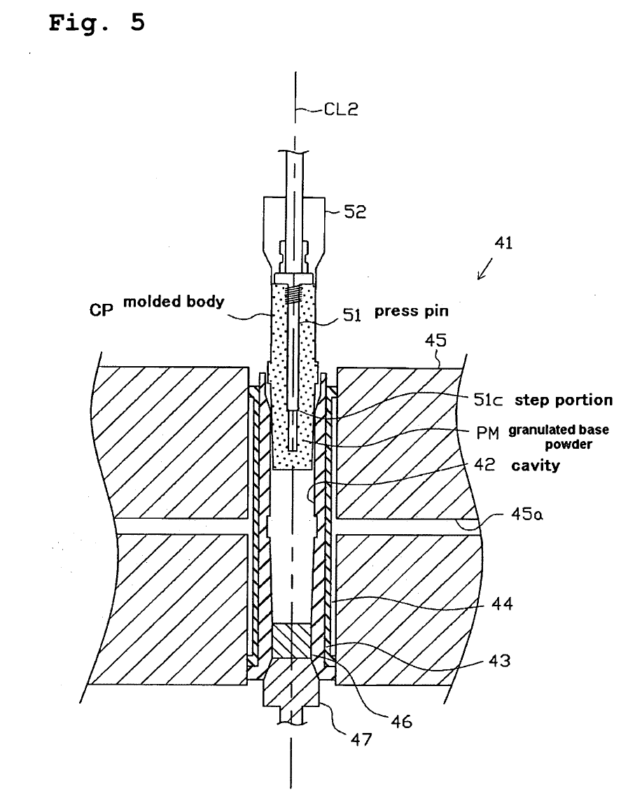

Next, applying the fluid pressure against the inner rubber die 43 and the outer rubber die 44 from the outer circumferential side through the fluid flow path 45a, size of the cavity 42 is reduced. In this way, the granulated base powder PM is compressed and molded. When the application of the fluid pressure is stopped after a predetermined time has elapsed, the inner rubber die 43 and the outer rubber die 44 elastically restore to their original shape, and the cavity also returns to its original shape. Subsequently, as shown in FIG. 5, when the press pin 51 is pulled up from the rubber press machine 41 in an axis CL2 direction, a molded body CP made of compressed granulated base powder PM is pulled out with the press pin 51 from the cavity 42. Then, the press pin 51 is pulled out of the molded body CP by rotating the press pin 51 relative to the molded body CP. In addition, a through hole of the molded body CP made by pulling out the press pin 51 therefrom serves as the axial bore 4, and the step portion 51c of the press pin 51 serves as the shoulder portion 4a in the axial bore 4.

In a cutting and grinding process, as shown in FIG. 2, the thus-obtained molded body CP is ground into an insulator intermediate body IP which has generally the same outer shape as that of the ceramic insulator 2. Then, the insulator intermediate body IP is calcined in a furnace in a firing process so as to obtain the ceramic insulator 2.

The center electrode 5 is separately manufactured from the metal shell 3 and the ceramic insulator 2. That is, nickel alloy is formed in a forging process, and the inner layer 5A made of copper alloy is formed in the center part of, the alloy in order to improve heat conduction.

Then, the thus-formed ceramic insulator 2, the center electrode 5, the resistor 7 and the terminal electrode 6 are sealed and fixed by the glass seal layers 8 and 9. Generally, the glass seal layers 8 and 9 are prepared by blending borosilicate glass and metal powder, and filled in the axial bore 4 of the ceramic insulator 2 so as to sandwich the resistor 7. Thereafter, the glass seal layers 8 and 9 are compressed by insertion of the terminal electrode 6 from the rear end, while heating it in the furnace. At this time, a glaze layer provided on a surface of the rear end side body portion 10 of the ceramic insulator 2 may be calcined simultaneously, or a glaze layer may be formed in advance.

Subsequently, the thus-formed ceramic insulator 2 provided with the center electrode 5 and the terminal electrode 6 is assembled together with the metal shell 3 having the ground electrode 27. More specifically, a relatively thin-walled rear-end opening portion of the metal shell 3 is caulked radially inward; i.e., the above-mentioned caulking portion 20 is formed, thereby fixing the ceramic insulator 2 and the metal shell 3 together.

Finally, the ground electrode 27 is bent so as to form the spark discharge gap 33 formed between the front end of the center electrode 5 and the front end of the ground electrode 27.

Through a series of steps mentioned above, the spark plug 1 having the above-mentioned configuration is manufactured.

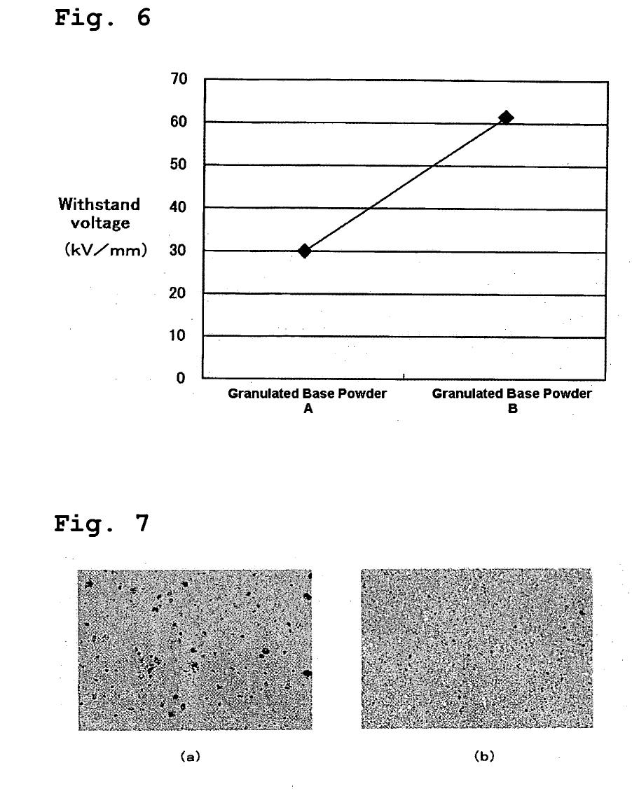

Next, in order to verify effects which the present embodiment yields, a withstand voltage evaluation test was conducted. The outline of the withstand voltage evaluation test is as follows. Granulated base powder A (comparative sample) having the granule strength of over 1 MPa and granulated base powder B (embodiment) having the granule strength of 1 MPa or less were molded into a disc-like shape by die-press molding (applied pressure was 100 MPa), respectively, so as to form molded samples. Then, the molded samples were calcined under the same conditions as the manufacturing process of the ceramic insulator to produce disc-like test samples having 0.65 mm in thickness and 25 mm in diameter. These disc-like test samples were sandwiched by a pair of rod-like electrodes, and a pair of cylindrical alumina shell is disposed so as to surround an outer circumferential face of the electrodes. The disc-like test samples and an alumina housing were fixed with sealing glass. Thereafter, the disc-like test samples and the pair of electrodes or the like were placed in a heating box having an electrical heater therein. The heating box was heated at 700 degrees C. with the electrical heater, the high voltage was applied to the disc-like test samples using a high-voltage generator (CDI). Withstand voltage value when a dielectric breakdown occurred was measured. The results of the withstand voltage evaluation test is shown in FIG. 6. FIG. 7(a) shows a cross-sectional face of the disc-like test sample made of granulated base powder A, and FIG. 7(b) shows a cross-sectional face of the disc-like test sample made of granulated base powder B. The granule strength of the granulated base powder A was about 1.2 MPa, and that of the granulated base powder B was about 0.5 MPa. The mean particle size of the particles that constitute the granulated base powder A and the mean particle size of the particles that constitute the granulated base powder B were 100 micrometers, respectively.

As shown in FIG. 6, the withstand voltage value of the disc-like test sample made of the granulated base powder A was about 30 kV/mm. On the other hand, the withstand voltage value of the disc-like test sample made of the granulated base powder B was 60 kV/mm or more, which is an excellent withstand voltage properties. As shown in FIGS. 7 (a) and (b), the size and the number of pores (black part in the figure), which causes spark penetration destruction, in the disc-like test sample decreased because the granulated base powder B whose granule strength was relatively small was employed.

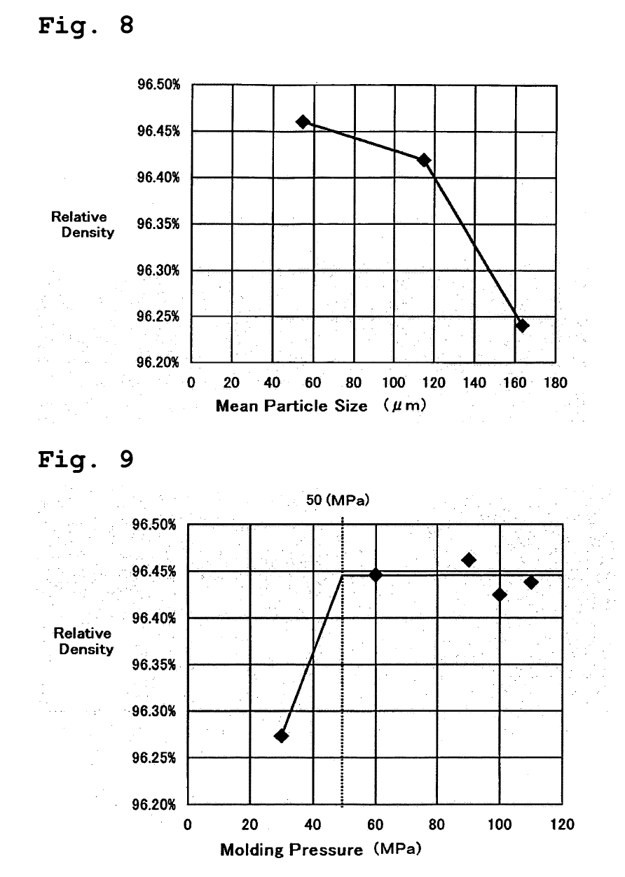

Subsequently, insulator samples for a spark plug were made of granulated base powder having various particle size so as to measure a relative density of each sample. FIG. 8 is a graph showing a relationship between the mean particle size and the relative density of the particles. In addition, the term “relative density” means a ratio to the theoretical density of the sintered compact density measured by the Archimedes method in units of percentage. Further, the term “theoretical density” means a density calculated by a mixing rule using an oxide conversion of each content of the element contained in a sintered compact. Notably, as a value of the relative density is greater, it shows that the sintered compact is densified, which leads to an improvement in withstand voltage properties.

As shown in FIG. 8, when the mean particle size exceeds 120 micrometers, the relative density drastically drops. The reason for this is that the size of the pore between the particles becomes relatively large. Therefore, in order to raise the relative density and materialize excellent withstand voltage properties, the mean particle size of the particles constituting the granulated base powder is preferably 120 micrometers or less. However, when the mean particle size is less than 60 micrometers, the mobility of granulated base powder deteriorates and the handling of the granulated base powder becomes difficult. Therefore, the mean particle size of the particles constituting the granulated base powder is preferably 60 micrometer or more to 120 micrometers or less.

Next, insulator samples for a spark plug were produced for measuring the relative density of each sample. The samples were made of granulated base powder B and subjected to the various molding pressure during the rubber press molding. FIG. 9 is a graph showing the relationship between the molding pressure and the relative density.

As shown in FIG. 9, when the molding pressure was 50 MPa or more, the relative density was large enough. The reason for this is that the granulated base powder having the granule strength of 1 MPa or less is fully compressed by setting the molding pressure to be 50 MPa or more, and the number of pores were assuredly decreased. In order to fully compress the granulated base powder, the molding pressure is preferably 60 MPa or more. However, when the molding pressure exceeds 150 MPa, the rubber die for molding is rapidly worn off, and a manufacturing cost may possibly increase. Therefore, it is preferable that the molding pressure be 150 MPa or less.

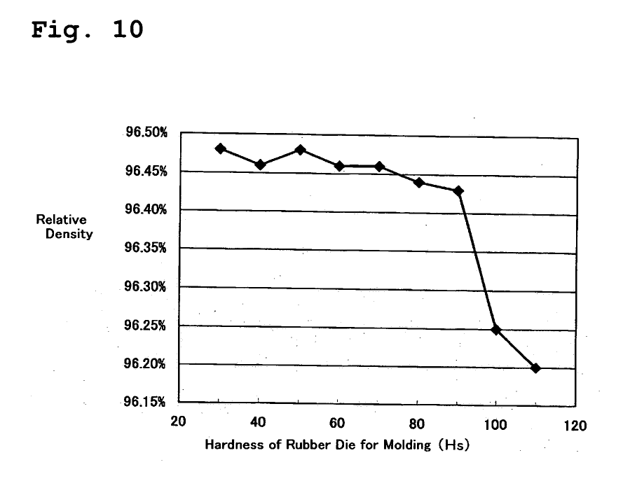

Subsequently, a plurality of rubber dies each having different hardness was prepared. Using each rubber die, insulator samples for spark plugs were made by the granulated base powder B through press molding. The relative density of each sample was measured. FIG. 10 is a graph showing a relationship between the hardness of the rubber die and the relative density of the sample.

Further, durability of each rubber die having different hardness was observed. The durability of rubber die was observed as follows. When the pressing process is repeatedly conducted, the rubber die deforms and the inner shape thereof (cavity) vary. Thus, the number of pressing process was counted at the time that the variation of the cavity exceeds a predetermined value. The mark “X” was awarded to those samples where the number of press processing times was less than the predetermined times, for insufficient durability. On the other hand, the mark “◯” was awarded to those samples where the number of press processing times was more than the predetermined times, for sufficient durability. Further, the mark “⊚” was awarded to those samples where the number of press processing times exceeded the predetermined times, for excellent durability. The relationship between the hardness and the durability of the rubber die is shown in Table 1.

TABLE 1

| | Hardness of Rubber Die (Hs) | | | | | | | | |
|---|---|---|---|---|---|---|---|---|---|
| | 30 | 40 | 50 | 60 | 70 | 80 | 90 | 100 | 110 |
| Durability Test | X | ◯ | ⊚ | ⊚ | ⊚ | ⊚ | ⊚ | ⊚ | ⊚ |

As shown in FIG. 10, the samples formed by a rubber die having the hardness of 90 Hs or less had sufficient relative density. On the other hand, as shown in Table 1, it was apparent that the rubber die having the hardness of 40 Hs or more had sufficient durability for the repeated use. Furthermore, the rubber die having the hardness of 50 Hs or more had further excellent durability.

As mentioned above, in order to materialize densification of the ceramic insulator and an improvement in withstand voltage properties, the granule strength of granulated base powder is preferably 1 MPa or less, while the mean particle size of the particles constituting the granulated powder preferably falls within a range from 60 micrometer or more to 120 micrometers or less.

In order to prevent an increment of the manufacturing cost as well as making the ceramic insulator dense, the molding pressure preferably falls within a range from 50 MPa or more to 150 MPa or less.

In addition, in order to assuredly compress the granulated base powder while maintaining a sufficient durability of the rubber die, the hardness of the rubber die is preferably 40 Hs or more to 90 Hs or less, more preferably 50 Hs or more to 90 Hs or less.

The shoulder portion 4a is formed by the step portion 51c of the press pin 51 in this embodiment, and the step portion 51c tapers off toward the front end side. Thus, the molding pressure is unlikely to be applied to the granulated base powder PM located in the circumference of the step portion 51c at the time of the rubber press molding. This might cause deterioration in mechanical strength and withstand voltage properties of a portion forming the shoulder portion 4a. However, according to this embodiment, since the molded body CP is made of the granulated base powder having the relatively small granule strength of 1 MPa or less, the particles constituting the granulated base powder PM can assuredly be crushed even if the molding pressure is not fully applied thereto. In this way, the density of the portion forming the shoulder portion 4a improves, and further improvement in mechanical strength and withstand voltage properties is achievable.

The present invention is not limited to the above-described embodiment, but may be embodied, for example, as follows. Of course, application examples and modifications other than those described below are also possible.

(a) According to the above-mentioned embodiment, the single step portion 51c is formed in the press pin 51. However, a plurality of step portions 51c may be provided.

(b) There is no limitation in particular for the cutting amount of the molded body CP in the cutting process. However, the insulator intermediate body IP may be formed with the cutting amount of less than 50% by mass of the molded body CP. In this case, difference in the density among the outer circumferential portion, the inner circumferential portion and an intermediate portion of the molded body CP can be made relatively small (i.e., the density of the molded body CP is uniform). Thus, the insulator intermediate body IP, consequently, the ceramic insulator 2 is less likely to have a non-uniform density among the outer circumferential portion, the inner circumferential portion, and the intermediate portion. As a result, further improvement in withstand voltage properties is achievable.

(c) According to the above-mentioned embodiment, the rubber die is comprised of the inner rubber die 43 and the outer rubber die 44 and has a non-bottomed shape. However, the rubber die may assume a bottomed shape.

(d) In the above-described embodiment, the ground electrode 27 is joined to the front end of the metal shell 3. The present invention is applicable to a ground electrode which is formed by grinding a part of a metal shell (or a portion of a front end metal that is welded in advance to a metal shell) (e.g., JP,2006-236906,A or the like). Further, the ground electrode 27 may also be joined to a side face of the front end portion of the metal shell 3.

(e) According to the above-mentioned embodiment, the tool engagement portion 19 assumes a hexagonal shape in the cross-section. However, it is not limited to such a shape. The tool engagement portion 19 may assume, for example, a Bi-HEX shape (irregular dodecagon) [ISO22977: 2005 (E)].

1. A method for manufacturing an insulator that is used for spark plugs and has an axial bore extending in an axis direction, comprising:
preparing slurry by mixing base powder into a solvent, the base powder containing aluminum oxide powder as a principal component and one or more kinds of sintering aid including silicon oxide;
granulating the slurry by spray drying to obtain granulated base powder;
filling the granulated base powder into a cavity of a cylindrical rubber die for molding;
compressing the granulated base powder by applying a pressure from a radial direction of the rubber die after disposing a rod-like press pin in the cavity so as to form a molded body;
cutting the molded body into a insulator intermediate body having a predetermined insulator shape,
wherein a mean particle size of particles which constitute the granulated base powder falls within a range from 60 micrometers or more to 120 micrometers or less, and wherein granule strength of the granulated base powder is 1 MPa or less.

2. The method for manufacturing the insulator used for spark plugs according to claim 1,
wherein a molding pressure in the compressing process falls within a range from 50 MPa or more to 150 MPa or less.

3. The method for manufacturing the insulator used for spark plugs according to claim 1 or 2,
wherein a cutting amount of the molded body in the cutting process is less than 50% by mass of the molded body.

4. The method for manufacturing the insulator used for spark plugs according to claims 1 or 2,
wherein the press pin is comprised of:
a small diameter portion formed at a front end side thereof;
a large diameter portion formed at a rear end side with respect to the small diameter portion and having a larger diameter than that of the small diameter portion; and
one or more step portion formed between the small diameter portion and the large diameter portion and tapering off toward the front end side, wherein the granulated base powder is filled in the filling process so as to cover at least the step portion.

5. The method for manufacturing the insulator for spark plugs according to claims 1 or 2,
wherein a hardness of the rubber die for molding falls within the range from 40 Hs or more to 90 Hs or less.

6. An insulator for spark plugs is manufactured by the method according to claims 1 or 2.

7. A spark plug is provided with the insulator according to claim 6.

8. A method for manufacturing a spark plug, the spark plug is manufactured using the insulator manufactured according to claims 1 or 2.
